(19) United States
(12) Patent Application Publication
(10) Pub. No.: US 2023/0250972 A9
(43) Pub. Date: Aug. 10, 2023

(54) CHEMICAL-AGENT DOSING APPARATUS

(71) Applicant: Bernard COOK, CHELTENHAM GLOUCESTERSHIRE (GB)

(72) Inventor: Bernard COOK, CHELTENHAM GLOUCESTERSHIRE (GB)

(21) Appl. No.: 17/774,019

(22) PCT Filed: Nov. 4, 2020
(86) PCT No.: PCT/GB2020/052789

§ 371 Date: May 3, 2022

(30) Foreign Application Priority Data
Nov. 4, 2019 (GB) 1916009.2

(51) Int. Cl. F24D 19/00; F24D 3/10; C02F 1/68; C02F 1/00

(52) U.S. Cl. CPC F24D 19/0092; F24D 3/1083; C02F 1/686; C02F 1/008; C02F 2209/01; C02F 2209/44; C02F 2209/03; C02F 2303/22; C02F 2303/08; C02F 2209/005

(57) ABSTRACT

A chemical-agent dosing apparatus for dosing a heating system with chemical agent. The apparatus comprises a chemical-agent storage chamber which stores a chemical agent and a dosing device which has a dosing chamber and a driving means. The dosing chamber is fluidly connected with the storage chamber and defines a dosing volume for receiving a dose of chemical agent. The driving means drives fluid from the dosing chamber via the dose outlet.

### RELATED APPLICATION

This application is based on prior filed copending International Application No. PCT/GB2020/052789 filed Nov. 4, 2020, which claims priority to Great Britain Application No. 1916009.2, filed Nov. 4, 2019, the entire subject matter of these applications is incorporated herein by reference in its entirety.

### TECHNICAL FIELD

The present invention relates to a chemical-agent dosing apparatus, in particular a chemical-agent dosing apparatus for a heating system. The invention further relates to a heating system, a method of maintaining a determined chemical-agent density, a chemical-agent storage chamber, and a method of installing a chemical-agent dosing apparatus.

### BACKGROUND

Corrosion can occur in heating systems given that heating systems conventionally include pipes formed from corrodible material, such as steel, which corrodes or rusts in the presence of heating fluid, such as water. The corrosion can cause degradation or damage to components of the heating system and may cause deposits of corrosion material, such as iron oxide, within the pipes which may result in blockages or partial blockages.

Additionally or alternatively, limescale build-up can occur in heating systems, particularly in areas of hard water. Limescale build-up may cause damage or blockages within the heating system.

Chemical agents may be used to prevent or limit corrosion or limescale build-up occurring within heating systems. Such chemical agents are added to the heating fluid of the heating system.

However, during use of the heating system, additional heating fluid may be required to be added to the heating system, for example to replace heating fluid which is lost from the system. Adding heating fluid to the system without including additional chemical agents results in a lower level or density of chemical agents in the fluid. This results in a higher risk of damage occurring to the heating system via corrosion or limescale build-up. The present invention seeks to provide a solution to these problems.

### SUMMARY

According to a first aspect of the present invention, there is provided a chemical-agent dosing apparatus for dosing a heating system with chemical agent, the apparatus comprising: a chemical-agent storage chamber for storing a chemical agent; and a dosing device having a dosing chamber and a driving means; the dosing chamber being fluidly communicable with the storage chamber, defining a dosing volume for receiving a dose of chemical agent, and including a dose outlet; the driving means being configured for driving fluid from the dosing chamber via the dose outlet.

A chemical agent storage chamber allows for a reservoir of chemical agent, such as inhibitors, to be provided at the heating system. By also providing a dosing device, the chemical agent can be provided to the heating system in known quantities. As such, a decrease in density or level of chemical agent within the heating system can be accurately counteracted by the application of one or more doses of chemical agent to the heating system. Furthermore, the chamber and dosing device allow for the apparatus to be automated such that user-input is not required to restore a density of chemical agent within the heating system to a recommended level.

Whilst described as a driving means, it will be appreciated that the driving means may also be termed as a driving device, a fluid driver, a driving element, or a pump.

Preferably, the storage chamber may be releasably engageable with the dosing device. As such, the storage chamber may be replaceable in use so as to add or replace chemical agent used by the additional apparatus.

Advantageously, the storage chamber and the dosing device may include interconnection means or connectors for interconnecting with each other, said interconnection means comprising one of interconnectable screw-threads, a push-fit connector, or a quarter-turn connector. Such interconnectors allow for convenient and fluid tight reversible connection between the storage chamber and the dosing device. Bayonet connectors may also be considered.

Preferably, the storage chamber may comprise a sealable external opening for receiving chemical agent therethrough. The sealable external opening may be closeable by a sealing cap, for example. This may allow for the storage chamber to be topped up from a dispensing bottle, for example.

Beneficially, the chemical-agent dosing apparatus may further comprise a valve between the storage chamber and the dose outlet. A valve prevents or limits chemical agent from unintentionally flowing or leaking from the storage chamber into the heating system.

Optionally, said valve may be at the dose outlet. This may prevent heating fluid from back-filling or entering the dosing chamber.

Additionally, the or another valve may be between the storage chamber and the dosing device.

Preferably, the dosing apparatus may further comprise a joining conduit which creates a joining fluid-flow-path external to the dosing chamber between a storage-chamber-proximal portion of the dosing chamber and an outlet-proximal portion of the dosing chamber, and a valve for closing said joining fluid-flow-path. A joining conduit allows for a closeable fluid connection to be made either side of the driving means, for example the piston. As such fluid may be able to selectably flow between two sides of the driving means, even if the driving means makes a fluid tight seal within the dosing chamber.

Advantageously, the valves are one-way valves. As such, backfill of the apparatus is prevented or limited. It will be appreciated that one or more of the valves may be a one-way valve without necessarily requiring the other valves to be present.

In a preferable embodiment, the driving means may comprise a piston in, at or fluidly communicable with the dosing chamber. A piston is a simple fluid driver able to drive fluid in two directions with a limited number of moving parts.

Beneficially, the chemical-agent dosing apparatus may further comprise a chemical-agent sensor for determining a density of chemical agent in the heating system. In this way a signal may be provided to a user to dose chemical agent into the heating system. Alternatively, the apparatus may automatically dose chemical agent into the system.

Additionally, the chemical-agent dosing apparatus may further comprise a controller communicatively connected to the sensor and the driving means so that the driving means is operable to drive chemical agent to the outlet when said density is less than or equal to a predetermined value.

Preferably, the dosing apparatus may further comprise a timing circuit for periodically instructing the dosing device to dose of chemical agent and/or for delaying the application of a further dose. Periodic dosing may prevent or limit the requirement of a sensor. A delay may prevent the sensor from instructing application of a further dose before an initial dose has distributed across the heating system.

According to a second aspect of the present invention, there is provided a heating system having a heating-fluid flow conduit and a chemical-agent dosing apparatus according to the first aspect of the invention.

Preferably, the heating system may further comprise a heating-fluid addition device for adding heating-fluid to the heating-fluid flow conduit. The heating-fluid addition device allows for heating-fluid to be automatically or manually added to the heating system in the event of heating-fluid or pressure loss. By including a chemical-agent dosing apparatus and a heating-fluid addition device, the chemical agent may be able to be added to the heating system to compensate for the additional heating fluid which is added and which would otherwise lower the level of chemical agent in the heating system.

Optionally, the heating system may further comprise a pressure sensor for determining a fluid pressure within the heating-fluid flow conduit. In this way a signal may be provided to a user to add heating-fluid into the heating system. Alternatively, the apparatus may automatically add heating-fluid into the system.

Advantageously, the or another controller may be communicatively connected to the pressure sensor and the heating-fluid addition device so that when the fluid pressure is less than or equal to a predetermined value, fluid may be added to the heating-fluid flow conduit. As such, user-intervention for adding heating-fluid is not required.

Preferably, the or another controller is communicatively connected between the dosing device and the pressure sensor or the heating-fluid addition device, so that the dosing device may automatically add chemical agent based on a or an intended heating-fluid addition. In this way a chemical-agent sensor may not strictly be necessary.

Beneficially, the system may further comprise a chemical-agent density sensor which may be received in a testing chamber which is fluidly communicable with and positioned off-axially relative to the heating-fluid flow conduit. A testing chamber allows for fluid to accumulate, mix and may slow down the fluid flow to allow for more accurate testing. Additionally or alternatively, the testing chamber may allow for larger sensors to be accommodated. Off-axial positioning may allow for easier installation.

Optionally, the dose outlet may be at or adjacent to the test chamber.

Preferably, the system may further comprise a chemical-agent density sensor which may be received in a testing chamber which is fluidly communicable with and positioned axially relative to the heating-fluid flow conduit. The fluid composition of an axially in-line testing chamber may more accurately reflect that within the heating system as a whole.

Advantageously, the dose outlet may be downstream of the or a chemical-agent density sensor. This may prevent or limit the sensor providing a false-reading of high chemical-agent level when chemical agent is added to the system. Thus, in the event that the heating-fluid addition device is configured to automatically add heating-fluid to reduce the chemical-agent level, this may be prevented or limited from occurring unnecessarily.

Beneficially, the heating-fluid addition device may be downstream of the or a chemical-agent density sensor. This may prevent or limit the sensor providing a false-reading of very low chemical-agent level when heating fluid is added to the system. Thus, in the event that the dosing device is configured to automatically add chemical agent to increase the chemical-agent level, this may be prevented or limited from occurring unnecessarily.

Alternatively, the heating-fluid addition device may be upstream of the chemical-agent density sensor. Therefore, the sensor may quickly identify that chemical agent will be required to be added to the system.

According to a third aspect of the present invention, there is provided a method of maintaining a determined chemical-agent density in a heating system according to the second aspect of the invention, the method comprising: a) adding heating-fluid to the heating-fluid flow conduit via the heating-fluid addition device; and b) driving chemical agent to the heating-fluid flow conduit via the outlet of the dosing chamber.

Preferably, the heating system may include a chemical-agent density sensor and the method further comprises a step c) between a) and b), step c) comprising: determining a density of chemical agent in the heating system via the chemical-agent sensor.

According to a fourth aspect of the present invention, there is provided a chemical-agent storage chamber for the chemical-agent dosing apparatus according to the first aspect of the invention.

According to a fifth aspect of the present invention, there is provided a method of installing a chemical-agent dosing apparatus according to the first aspect of the invention the method comprising connecting the outlet to a heating-fluid flow conduit heating system.

### BRIEF DESCRIPTION OF THE DRAWINGS

The invention will now be more particularly described, by way of example only, with reference to the accompanying drawings, in which:

FIG. 1 shows a first embodiment of a chemical-agent dosing apparatus, in accordance with a first aspect of the invention, in use with a chemical agent being added to a heating system;

FIG. 2 shows the chemical-agent dosing apparatus of FIG. 1 in use with chemical agent in a dosing chamber being compressed;

FIG. 3 shows the chemical-agent dosing apparatus of FIG. 1 in use with chemical agent moving from a storage-chamber-proximal portion of the dosing chamber to an outlet-proximal portion of the dosing chamber;

FIG. 4 shows a portion of a first embodiment of heating system according to a second aspect of the invention;

FIG. 5 shows a portion of a second embodiment of heating system according to a second aspect of the invention

FIG. 6 shows a portion of a third embodiment of heating system according to a second aspect of the invention; and

FIG. 7 shows a portion of a fourth embodiment of heating system according to a second aspect of the invention.

### DETAILED DESCRIPTION

Referring firstly to FIGS. 1 to 3, there is shown a first embodiment of a chemical-agent dosing apparatus 10 for adding or dosing a chemical agent to a first embodiment of a heating system 12, particularly a heating-fluid flow conduit 14 of a heating system 12.

The term chemical agent includes any substance which may be added to the fluid of a heating system 12 to improve the lifespan, operation or efficiency of the heating system 12. Such chemical agents include inhibitors such as corrosion-inhibiting agents or limescale- or scale-inhibiting agents. The chemical agent is preferably a liquid such as a solution but may also be a solid such as a powder or cake, or a gas. The chemical agent does not consist only of water.

Corrosion-inhibiting agents may include chemicals for removing oxygen from the heating fluid. These may be termed reductive inhibitors, for example amines or hydrazine. Exemplar amines include hexamine, phenylenediamine, dimethylethanolamine, and their derivatives. Antioxidants such as sulfites and ascorbic acid could also be used. Alternatively, corrosion inhibitors which form a passivating coating on the surface of the heating fluid flow conduit may also be considered, such as benzotriazole.

Limescale- or scale-inhibiting agents may include acrylic acid polymers, maleic acid polymers, phosphonates or other acidic compounds. For example, phosphonobutane-1,2,4-tricarboxylic acid, amino-trimethylene phosphonic acid, polyacrylic acid, phosphinopolyacrylates or sulfonated phosphonocarboxylic acid. Alternatively or additionally, limescale-inhibiting agents may include water softening compounds, such as salt or calcium hydroxide.

The chemical-agent dosing apparatus 10 comprises a chemical-agent storage chamber 16 for storing a chemical agent, and a dosing device 18.

The storage chamber 16 may otherwise be considered to be a vessel and may have any size or shape including cylindrical or cuboidal. The storage chamber 16 may have an opening for addition of chemical agent and such an opening may be sealable, for example via a sealable cap. Preferably, the storage chamber 16 is separable from the dosing device 18 and/or the remainder of the apparatus 10. For example, as shown in FIG. 4, the storage chamber 16 has a screw thread 120a at a storage-chamber outlet 122 or storage-chamber port for interconnection with a corresponding screw thread 120b on the dosing device 18 or a body of the apparatus 10. Whilst a screw thread is provided, it will be appreciated that other releasable attachment means or connectors may be provided, for example a bayonet fitting, a push-fit connector, or a quarter-turn connector. Additionally, the storage chamber could be permanently attached to the dosing chamber 26 or be integrally formed therewith.

There is preferably a storage-chamber valve 24 between the storage chamber 16 and the dosing device 18. In the instance of the storage chamber 16 and dosing device 18 being separable, the storage-chamber valve 24 may be at or on the storage chamber 16, or at or on the dosing device 18. The storage-chamber valve 24 may be a one-way valve or a non-return valve and is preferably activatable or actuatable between open and closed conditions via fluid pressure. For example, the storage-chamber valve 24 may be actuated to an open condition via higher pressure in the storage chamber 16 than in the dosing device 18, and being actuated to a closed condition via lower pressure in the storage chamber 16 than in the dosing device 18. As such the storage-chamber valve 24 may be pivotably connected relative to the storage chamber 16 and/or dosing device 18 such that movement towards the storage chamber 16 beyond the closed condition is prevented or limited. Alternatively, the storage-chamber valve 24 may be manually, electrically, or mechanically activatable or operable.

The dosing device 18 comprises a dosing chamber 26 and a driving means 28 or fluid driver. The dosing chamber 26 defines a dosing volume for receiving a dose of chemical agent and has a dose outlet 30 for said dose to pass through to be added to the heating system 12. Preferably, the dosing chamber 26 is elongate. The dosing chamber 26 is fluidly communicable with the dosing device 18. Preferably, the dosing chamber 26 includes a dosing valve 32. Said dosing valve 32 is preferably at the dose outlet 30, although it will be appreciated that the dosing valve 32 may be proximal or distal to the dosing chamber 26 relative to the outlet 30. The dosing valve 32 is preferably a one-way valve such that when fluid in the dosing chamber 26, or portion of the dosing chamber 26 adjacent to the dosing valve 32, has a higher pressure than fluid external and downstream of the valve, the valve 32 is open. When the external and downstream fluid has a higher pressure than the fluid in the dosing chamber 26, or portion of the dosing chamber adjacent to the dosing valve 32, the valve 32 is open.

Whilst described as a driving means 28, it will be appreciated that the driving means 28 may also be considered to be a pressure-generating means or a pressure-differential generator given that the fluid is driven by a generation of a pressure-differential between two locations.

The driving means 28 preferably includes a piston 34 in, at or fluidly communicable with the dosing chamber 26. Preferably, the piston 34 is located in the dosing chamber 26. More preferably, the cross-sectional area of the dosing chamber 26 matches or substantially matches that of the piston 34, or more specifically the piston head 36. In this way the piston 34 or piston head 36 may make a fluid seal or substantial fluid seal with walls of the dosing chamber 26 such that the dosing chamber 26 may be considered to be the cylinder of the piston 34. It will be appreciated that the cross-sectional area of a piston head 36 and the dosing chamber 26 may not necessarily be circular. The dosing chamber 26 preferably defines a specific known volume for receiving a dose of chemical agent of corresponding volume.

The piston 34 is preferably moveable from a storage-chamber-proximal portion 26a of the dosing chamber 26 to a dose-outlet-proximal portion 26b of the dosing chamber 26. A joining conduit 38 creates a joining fluid-flow-path external to the dosing chamber 26 between the storage-chamber-proximal portion 26a and the dose-outlet-proximal portion 26b. A joining-conduit valve 40 may be in or at the joining conduit 38 and here the joining-conduit valve 40 is at a dose-outlet proximal end 42 of the joining conduit 38. The joining-conduit valve 40 is preferably a one-way valve such that when fluid in the joining conduit 38 has a higher pressure than fluid in the dosing chamber 26, or portion of the dosing chamber 26 adjacent to the joining-conduit valve 40, the valve 40 is urged open. When the dosing chamber 26 fluid has a higher pressure than the fluid in the dosing chamber 26, or portion of the dosing chamber 26 adjacent to the joining-conduit valve 40, the valve 40 is closed, for example by back pressure of the fluid in the heating system.

The piston 34 and/or piston head 36 preferably overlaps the dose-outlet proximal end 42 of the joining conduit 38 such that it may form a fluid seal thereto.

In use, and referring to FIG. 1, the dosing device 18 is fluidly connected to the heating system 12 so that the dose outlet 30 is at an inlet to a heating-system fluid conduit. A chemical agent is received within the chemical-agent storage chamber 16. For example, the chemical-agent storage chamber 16 may be a vessel or canister which is pre-loaded with chemical agent. The chemical-agent storage chamber 16 is then attached and fluidly communicated with the dosing device 18. For example, corresponding screw-threads are interengaged. To allow the storage chamber 16 to be connected to the dosing device 18 with the storage-chamber outlet 22 facing downwards, the storage-chamber outlet 22 may be covered by a seal which is broken when the storage chamber 16 is attached to the dosing device 18. Alternatively, chemical agent may be added into the storage chamber 16 via an opening therein.

At this point when first connecting the storage chamber, the dosing device 18 may be filled with fluid from the heating system 12 and the piston 34 may be at the storage-chamber-proximal portion 26a of the dosing chamber 26. The piston 34 then moves, as indicated by arrow A, towards the dose-outlet-proximal portion 26b of the dosing chamber 26. This creates high pressure forward or downstream of the piston 34 and therefore causes the dosing valve 32 to open and the joining-conduit valve 40 to close. Thus, the fluid forward of the piston 34 is driven or ejected from the dosing chamber 26 and thus is injected into the heating system 12, as indicated by arrow B.

Simultaneously, the movement of the piston 34 generates low pressure in the dosing chamber 26 behind or upstream of the piston 34. This causes the storage-chamber valve 24 to open and chemical agent to be drawn into the dosing chamber 26 upstream or behind the piston 34, as indicated by arrow D. Chemical agent is prevented from flowing directly from the storage chamber 16 to the dosing outlet 30 by the joining-conduit valve 40, as indicated by line E.

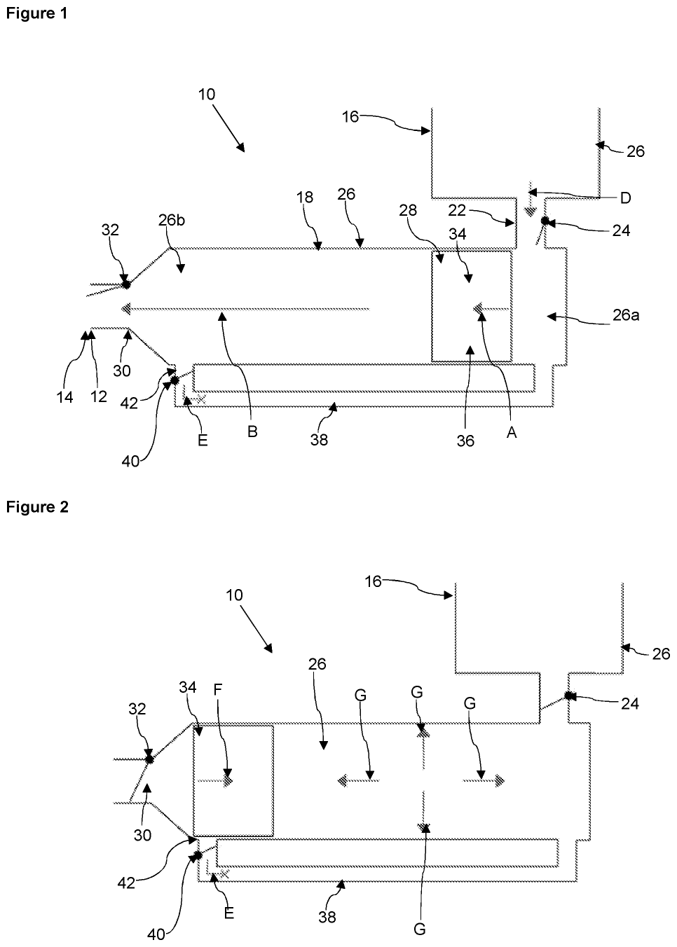

Referring to FIG. 2, the piston 34 preferably moves to being at or adjacent to the dose outlet 30 so as to maximise the chemical agent received in the dosing chamber 26. A dose of chemical agent is thus received within the dosing chamber 26 The piston head 36 preferably covers and seals the dose-outlet proximal end 42 of the joining conduit 38.

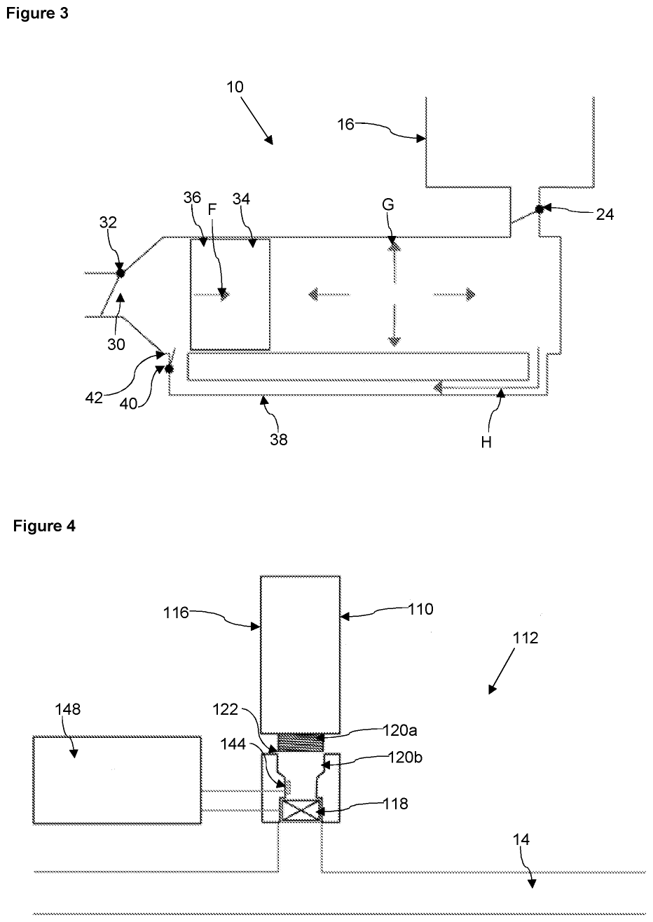

The piston 34 then moves towards the storage chamber 16, as shown by arrow F, which generates high pressure within the dosing chamber 26 between the piston 34 and the storage chamber 16, as shown by arrows G. This closes the storage-chamber valve 24. Low pressure is created between the piston 34 and the dose outlet 30 which closes the dosing valve 32. Once the piston 34 moves beyond the dose-outlet proximal end 42 of the joining conduit 38, the joining-conduit valve 40 is opened, as shown in FIG. 3. This causes the chemical agent dose in the dosing chamber 26 between the piston 34 and the storage chamber 16 to move via the joining fluid-flow-path and to the dosing chamber 26 between the piston 34 and the dosing valve 32, as shown by arrow H.

A volume of dose of chemical agent can be defined as an internal volume of the dosing chamber 26 between two terminal positions of the piston 34. As such, a known amount of chemical agent may be injected into the heating system 12 for each cycle of the piston 34. However, it will be appreciated that the piston 34 may be moved only part way between the positions to define a proportion of the volume of dose.

With the piston 34 at or adjacent to the storage chamber 16, the piston 34 can then be moved towards the dose outlet 30 to result in the dose of chemical agent being injected into the heating system 12. The cycle of the piston 34 can be repeated to inject further doses or proportions of doses into the heating system 12.

Referring to FIG. 4, there is shown a portion of a second embodiment of a heating system 112 having a second embodiment of the dosing apparatus 110, the dosing device 118 symbolically represented. Similar or identical referencing numerals as used for first embodiment of the heating system are used for the second embodiment of the heating system, with ‘100’ added. The second embodiment of the dosing apparatus 110 may comprise a storage-chamber sensor 144, for example to sense the composition or presence of fluid at, adjacent to or in the storage chamber 116. The second embodiment of the dosing apparatus 110 may otherwise be similar or identical to the first embodiment.

The storage-chamber sensor 144 may be a fluid sensor and as such it may determine whether the chemical agent from the storage chamber 116 is at a low level, and thus whether additional chemical agent may need to be added to the storage chamber 116 or the storage chamber 116 replaced. Alternatively, the storage-chamber sensor 144 may sense the density of chemical agent at or adjacent to the storage chamber 116 to determine whether heating-system fluid has backfilled to the storage chamber 116, and thus whether this fluid needs to be removed to prevent fluid with insufficient chemical agent being dosed to the heating system 112. The storage-chamber sensor 144 may sense the density of chemical agent via any appropriate means, as will be better understood below. The storage-chamber sensor 144 may be communicatively connected to a controller 148, which may in turn be communicatively connected to the dosing device 118. The controller 148 may therefore activate the dosing device 118 based on the measurement of the sensor 144, for example to take account of any back-filled heating fluid when adding chemical agent into the system 112.

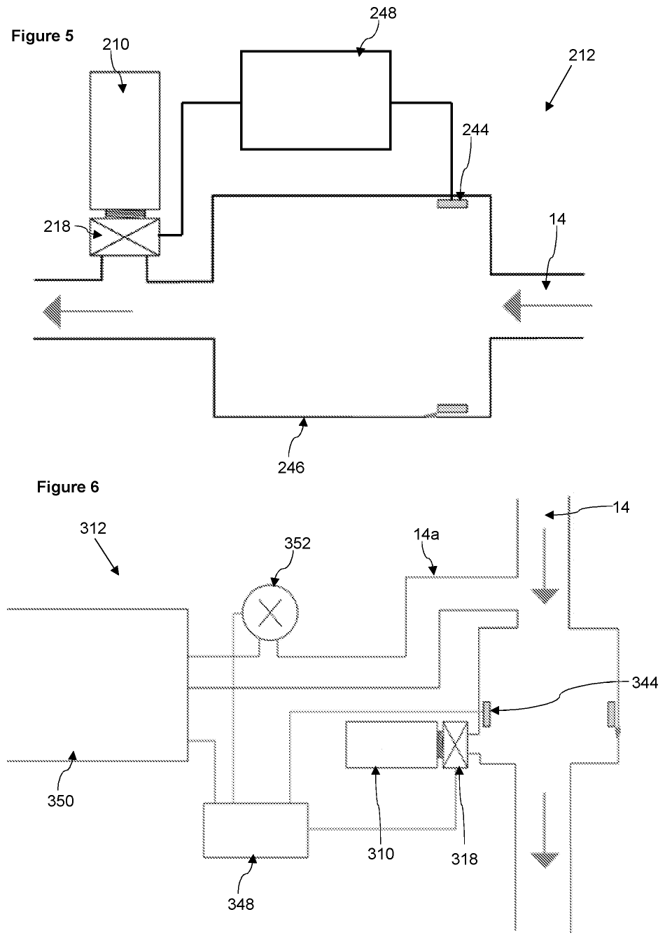

Referring to FIG. 5, there is shown a portion of a third embodiment of a heating system 212 with an embodiment of a representation of a dosing apparatus 210. The dosing apparatus may be similar or identical to the first or second embodiments of the dosing apparatus. Similar or identical referencing numerals as used for second embodiment of the heating system are used as for the third embodiment of the heating system, with ‘100’ added. The heating system 212 and/or the dosing apparatus 210 may comprise a heating-system-fluid sensor 244, or chemical-agent sensor, for determining a density or level of chemical agent in the fluid of the heating system 212. The sensor 244 may determine the density of chemical agent via an appropriate means for the type of chemical agent. For example, the type of chemical agent used may alter one or more of the following properties of the heating-system fluid: acidity, alkalinity, conductivity, colour, refractive index, wavelength or the wavelength distortion therethrough. As such, depending on the type of chemical agent used and how it affects the properties of the heating-system fluid, the sensor may monitor one or more of these properties.

The heating-system-fluid sensor 244 is here a two-part sensor, for example an optical emitter and sensor, although it will be appreciated that unitary part sensors may be considered.

The heating-system-fluid sensor 244 may be provided within a body of the dosing apparatus 210, for example at or adjacent to the outlet of the dosing device. Alternatively, the heating-system-fluid sensor 244 may be within a heating-system heating-fluid flow conduit 14 and thus axially in-line therewith, and as such may be within the main fluid flow path of the system. Preferably, there is a testing chamber 246. The testing chamber 246 is here axially in-line with the heating-system heating-fluid flow conduit 14 and has a diameter greater than a diameter of the heating-fluid flow conduit 14. The greater diameter of the testing chamber 246 may provide space for the sensor to be received and/or may slow the flow of fluid therethrough to assist with taking an accurate measurement of chemical-agent density. The testing chamber 246 may have connectors, such as screw-threaded or push-fit connectors to help installation to the heating-system fluid flow conduit. Whilst a testing chamber 246 is illustrated, it will be appreciated that a testing chamber may not be necessary and the sensor may be directly within the heating-fluid flow conduit 14, for example within the through-bore of the heating-fluid flow conduit 14.

The test chamber and/or sensor is here upstream of the dosing apparatus 210, although it will be appreciated that it may in fact be downstream of the dosing apparatus.

In use, the heating-system-fluid sensor 244 may measure or determine the density or level of chemical agent within the heating fluid.

If a controller 248 is used, the heating-system-fluid sensor 244 may report to the controller 248 that the density is below that of the predetermined value, and/or may report by how much the density is below that of the predetermined value. The controller 248, which may be communicatively connected to the dosing device 218, can then instruct the dosing device 218 to inject a dose, or the required number of doses based on the volume of the heating system 212, into the heating-system heating-fluid flow conduit 14. If the sensor can only indicate whether the density is or is not below that of the predetermined value, then the controller 248 may include a timing circuit for a delay such that the dosing device 218 does not repeatedly inject doses before an initial dose has had time to distribute across the heating-system heating-fluid flow conduit 14. Such a timing circuit could create short periods of delay, for example for between 1 and 20 minutes, to allow the dose to distribute across the circuit. Alternatively, the timing circuit could activate the dosing device periodically, for example having delays of durations between one month and two years, such as six-months or one-year delays, based on the typical depletion of active chemical agent within the heating system fluid flow conduit 14. As such the sensor 244 may not be required in this instance.

In order to dose the correct quantity of chemical agent, the sensor 244 may provide a chemical-agent density reading to the controller 248. The controller 248 may then determine the correct quantity of chemical agent based on the total volume of the heating-fluid flow conduits 14 of the heating system 212. A value or approximate value of the total volume of the heating-fluid flow conduits 14 may be input into the controller 248 during installation of the apparatus 210. The controller may multiply the total volume by the difference between a recommended chemical-agent density and a measured chemical-agent density. This may result in the total volume of chemical agent to be dosed, which may be administered by one, a portion of one, or multiple cycles of the dosing system.

The controller 248 may be local to the dosing apparatus 210 and heating system 212. Alternatively, the controller 248 may be distant from the dosing apparatus 210 and heating system 212, for example being a controller of a building management device wirelessly connected to the heating-system-fluid sensor 244 and the dosing device 218.

If a controller is not used or present, then the sensor 244 may indicate that additional chemical agent is required, for example via illuminating a light. Alternatively, the sensor may indicate a number on an electronic display to inform a user of the number of doses which are required to be added to the heating system 212. A user may then manually activate the dosing device 218, for example via an electrical or electronic control or via manual actuation such as a slider or lever.

Referring to FIG. 6, there is shown a portion of a fourth embodiment of a heating system 312. Similar or identical referencing numerals as used for third embodiment of the heating system are used for the fourth embodiment of the heating system, with ‘100’ added. The heating system 312 additionally comprises a heating-fluid addition device 350 for adding heating fluid to the heating-fluid flow conduit 14. The heating-fluid addition device 350 may, for example, be directly connected to an external fluid source, such as the mains water supply. The heating-fluid addition device 350 may automatically add heating fluid to the heating-fluid flow conduit 14. For this, the heating system 312 may also include a pressure sensor 352 for determining a fluid pressure within the heating-fluid flow conduit 14. The pressure sensor 352 is communicatively connected to a controller 348 so that the heating-fluid addition device 350 adds heating fluid to the heating-fluid flow conduit 14 when said fluid pressure falls below a predetermined value.

The heating-fluid addition device 350 and the pressure sensor 352 are here located on a side conduit 14a to the main flow path of the heating-fluid flow conduit 14, although it will be appreciated that they may be on separate side conduits or at the main flow-path of the heating-fluid flow conduit 14.

The controller 348 may be connected to the dosing device 18 of the chemical-agent dosing apparatus 310. The dosing apparatus may be similar or identical to the first or second embodiments of the dosing apparatus. When the controller 348 instructs the heating-fluid addition device 350 to add heating fluid, the controller 348 may also instruct the dosing device 318 to add chemical agent. Preferably, the controller 348 instructs the dosing device 318 to add a number of doses so that the density of chemical agent within the heating fluid remains similar or identical despite the addition of heating fluid, which does not contain said chemical agent. As such, it will be appreciated that a heating-system-fluid sensor 344, or chemical agent-sensor, may not be necessary.

However, the heating-system-fluid sensor 344 may be included even if the controller 348 instructs the dosing device 318 to add chemical agent based on additions from the heating-fluid addition device 350.

Here the sensor is downstream of the heating-fluid addition device 350. However, it will be appreciated that the heating-fluid addition device 350 may in fact be downstream of the sensor. The outlet of the chemical-agent dosing apparatus 310 is at or adjacent to the testing chamber 346, although it will be appreciated that this may not necessarily be the case.

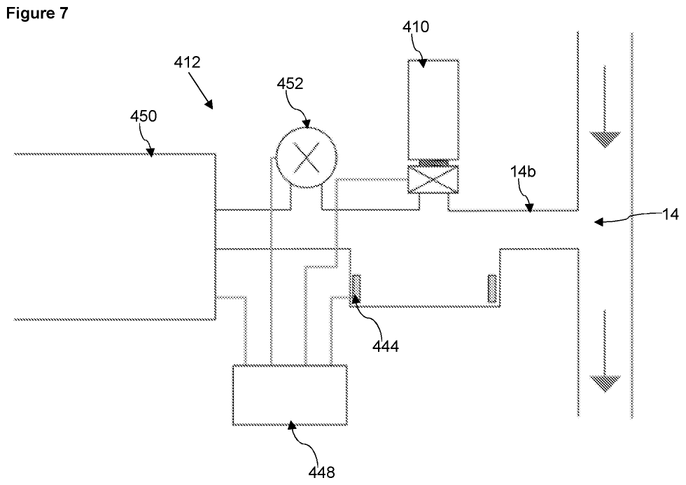

Referring to FIG. 7, a fifth embodiment of a heating system 412 and a representation of a chemical-agent dosing apparatus 410 is shown. Similar or identical referencing numerals as used for fourth embodiment of the heating system are used for the fifth embodiment of the heating system, with ‘100’ added. The dosing apparatus may be similar or identical to the first or second embodiments of the dosing apparatus. The heating-system-fluid sensor 444 and the testing chamber 446 are in or at the same side conduit 14b as the heating-fluid addition device 450 and downstream thereof. A controller 448 and pressure sensor 452 are also shown.

It is therefore possible to provide a chemical agent dosing apparatus which can be fitted to a heating system to allow for chemical agents, such as corrosion or limescale inhibitors, to be automatically topped up into the heating system. This may be particularly useful in the instance of a heating-fluid addition device which automatically tops up heating fluid in the event of fluid or pressure loss, and thus reduces a density or level of chemical agent in the heating system.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A chemical-agent dosing apparatus for dosing a heating system with chemical agent, the apparatus comprising:
a chemical-agent storage chamber for storing a chemical agent; and
a dosing device having a dosing chamber and a driving means;
the dosing chamber being fluidly communicable with the storage chamber, defining a dosing volume for receiving a dose of chemical agent, and including a dose outlet;
the driving means being configured for driving fluid from the dosing chamber via the dose outlet.

2. The chemical-agent dosing apparatus as claimed in claim 1, wherein the storage chamber is releasably engageable with the dosing device.

3. The chemical-agent dosing apparatus as claimed in claim 1, wherein the storage chamber and the dosing device interconnect with each other using any one of: interconnectable screw-threads; a push-fit connector; or a quarter-turn connector.

4. (canceled)

5. The chemical-agent dosing apparatus as claimed in claim 1, further comprising a valve between the storage chamber and the dose outlet.

6. The chemical-agent dosing apparatus as claimed in claim 5, wherein said valve is at the dose outlet and/or the or another valve is between the storage chamber and the dosing device.

7. The chemical-agent dosing apparatus as claimed in claim 1, wherein the dosing device further comprises a joining conduit which creates a joining fluid-flow-path external to the dosing chamber between a storage-chamber-proximal portion of the dosing chamber and an outlet-proximal portion of the dosing chamber, and a valve for closing said joining fluid-flow-path.

8. The chemical-agent dosing apparatus as claimed in claim 5, wherein the valves are one-way valves.

9. The chemical-agent dosing apparatus as claimed in claim 1, wherein the driving means comprises a piston in, at or fluidly communicable with the dosing chamber.

10. The chemical-agent dosing apparatus as claimed in claim 1, further comprising a chemical-agent sensor for determining a density of chemical agent in the heating system.

11. The chemical-agent dosing apparatus as claimed in claim 10, further comprising a controller communicatively connected to the sensor and the driving means so that the driving means is operable to drive chemical agent to the outlet when said density is less than or equal to a predetermined value.

12. The chemical-agent dosing apparatus as claimed in claim 1, further comprising a timing circuit for periodically instructing the dosing device to dose chemical agent and/or for delaying the application of a further dose.

13. A heating system having a heating-fluid flow conduit and a chemical-agent dosing apparatus as claimed in claim 1.

14. The heating system as claimed in claim 13, further comprising a heating-fluid addition device for adding heating-fluid to the heating-fluid flow conduit.

15. The heating system as claimed in claim 13, further comprising a pressure sensor for determining a fluid pressure within the heating-fluid flow conduit.

16. The heating system as claimed in claim 14, further comprising a pressure sensor for determining a fluid pressure within the heating-fluid flow conduit, wherein the or a further controller is communicatively connected to the pressure sensor and the heating-fluid addition device so that when the fluid pressure is less than or equal to a predetermined value, heating-fluid may be added to the heating-fluid flow conduit.

17. The heating system as claimed in claim 14, further comprising a pressure sensor for determining a fluid pressure within the heating-fluid flow conduit, wherein the or a further controller is communicatively connected between the dosing device and the pressure sensor or the heating-fluid addition device, so that the dosing device may automatically add chemical agent based on a or an intended heating-fluid addition.

18. The heating system as claimed in claim 13, further comprising a chemical-agent density sensor which is received in a testing chamber which is fluidly communicable with and positioned axially or off-axially relative to the heating-fluid flow conduit.

19. (canceled)

20. The heating system as claimed in claim 13, wherein the dose outlet is downstream of the or a chemical-agent density sensor.

21. The heating system as claimed in claim 14, wherein the heating-fluid addition device is downstream of the or a chemical-agent density sensor.

22. A method of maintaining a determined chemical-agent density in a heating system as claimed in claim 13, the method comprising the steps of:
a) adding heating-fluid to the heating-fluid flow conduit via the heating-fluid addition device; and
b) driving chemical agent to the heating-fluid flow conduit via the outlet of the dosing chamber.

23. (canceled)

24. (canceled)

25. (canceled)
